(19) United States
(12) Patent Application Publication
(10) Pub. No.: US 2014/0020774 A1
(43) Pub. Date: Jan. 23, 2014

(54) CHECK VALVE HAVING AN OPTIMIZED CLOSING ELEMENT

(71) Applicants: Juergen Miklo, Thayngen (CH); Markus Roost, Rafz (CH); Riccardo Barbone, Schaffhausen (CH)

(72) Inventors: Juergen Miklo, Thayngen (CH); Markus Roost, Rafz (CH); Riccardo Barbone, Schaffhausen (CH)

(73) Assignee: Georg Fischer Rohrleitungssysteme AG, Schaffhausen (CH)

(21) Appl. No.: 13/996,612

(22) PCT Filed: Dec. 14, 2011
(86) PCT No.: PCT/EP2011/072691

§ 371 Date: Oct. 2, 2013

(30) Foreign Application Priority Data
Dec. 22, 2010 (EP) 10196422.9

(51) Int. Cl. F16K 15/06

(52) U.S. Cl. CPC F16K 15/063
USPC 137/537

(57) ABSTRACT

A check valve (1) comprising a valve housing (2) in which a one-piece closing element (3) is present, which is arranged such that same can be displaced by the flow medium and contacts a profile seal (5) of a sealing section (7) in the closed position, wherein the closing element is guided by a bearing (10), wherein the bearing is disposed concentrically in the valve housing by ribs (11), wherein the closing element comprises a zone A (34) in which the outer contour comprises a flow-optimized shape and a zone B (35) in which the outer contour comprises a domed shape, and the zones A and B are disposed one after the other and transition smoothly into each other.

### BACKGROUND OF THE INVENTION

The invention relates to a check valve comprising a valve housing in which a one-piece closing element is present, which is arranged in such a way that same can be displaced by the flow medium and rests against a profile seal of a sealing section in the closed position, and which is guided by a bearing, wherein the bearing is arranged concentrically in the valve housing by means of ribs.

The purpose of a check valve is to determine the flow direction of a gaseous or liquid medium within a pipe conduit. They are used in gas, water or similar supply conduits in order to prevent backflow of the medium counter to the normal direction of throughflow. The check valve thus has the function of automatically shutting off the passage of a medium in the opposite flow direction or of shutting off when there is an absence of medium flowing in the flow direction.

Most of the check valves known from the prior art have a ball as a closing element since balls ensure optimum leaktightness in the closed position. The disadvantage with such check valves is that, when the valve opens, there is immediately a large throughflow cross section, giving rise to turbulence and allowing vibration to occur, the ball serving as a closing element being thrown backward and forward. This gives rise to abrasion and pitting on the closing element, with the result that it is not possible to ensure a satisfactory sealing effect in the closed position in the long term. Moreover, the abrasion and pitting contaminate the medium and, as a result, there may be damage to the pipe conduit system itself and to installed valves, pumps and fittings.

Apart from the desired property of optimum sealing through the shape thereof and the resulting optimum snug fit with the seal, a ball as a closing element also entails unwanted vibration and fluttering of the ball, giving rise to a large amount of noise.

Another unwanted property arising from a ball as a closing element is the unstable flow coefficient, which serves as a measure of the achievable flow of a medium through a valve.

Another disadvantage with a check valve that has a ball is the unfavorable result of adding an installable spring to the valve, something that is virtually impossible in most cases. A spring installed in the valve exerts a spring pressure on the closing element or ball, thus closing the latter in an optimum manner by means of an additional spring force produced by the spring. In the case of check valves having balls as a closing element, however, retrofitting a spring is possible only with difficulty since there are no supporting surfaces for the spring on the closing element or in the housing, and it would therefore be necessary to produce a special valve housing and a matching closing element for a spring version of a check valve, and this, in turn, would be associated with additional costs.

EP 0 047 055 B1 discloses a valve which has a ball produced from flexible plastic, which is pressed by a spring into a conical member and this, in turn, is pressed in a sealing manner against the conical bore at the larger diameter of the frustoconical outer surface, with the flexible ball furthermore being pressed against the conical bore and thereby producing a further seal.

The disadvantage with such a variant is the large number of individual parts and hence the high production costs and, furthermore, a ball without a seam or gate mark or other irregularities can be produced by mechanical machining, e.g. turning, from any material, or must at least be mechanically reworked; otherwise, the behavior of the ball in the valve would be considerably less stable.

It is the object of the invention to propose a check valve which ensures an improved flow coefficient and constancy thereof as well as optimum leaktightness; moreover, unwanted vibration of the closing element is to be avoided and, consequently, noise generation is to be reduced.

### SUMMARY OF THE INVENTION

According to the invention, this object is achieved by virtue of the fact that the closing element comprises a zone A, in which the outer contour comprises a flow-optimized shape, and a zone B, in which the outer contour comprises a domed shape, and zones A and B are arranged in series and merge smoothly into one another. By virtue of the flow-optimized contour in zone A, as low as possible resistance is caused in the conduit or in the valve, and this in turn ensures a very good flow coefficient. At the tip or at the front of the closing element, the flow-optimized shape of the outer contour in zone A has a radius which ensures that the flow is automatically distributed in a completely uniform manner. The circumference or diameter of the outer contour in zone A increases in the flow direction until zone A merges into zone B, thus ensuring laminar flow. The curve of zone A tangentially adjoins the dome in zone B.

A preferred embodiment consists in making the outer contour of zone A of the closing element of conical design, allowing a simplification of production and at the same time bringing about optimum flow in the valve or low resistance.

In zone B, the outer contour changes to the shape of a dome. The curve of zone A thus tangentially adjoins the outer contour of a sphere or dome. The shape of the sphere or dome provides the check valve with optimum sealing, although it is not a preferred option for minimizing resistance during flow or while the valve is open, that is to say that, by virtue of its shape, which does not have a rounded tip at the front of the closing element and is not optimized in terms of flow engineering, a ball used as a closing element causes very high resistance in the flow while the valve is open and, therefore, according to the invention, the minimized-resistance curve or outer contour of zone A is positioned ahead of the spherical shape or domed shape in zone B in the direction of the valve inlet, and these are connected to one another tangentially.

Further along the profile of the closing element there follows zone C, which, adjoining the spherical shape or domed shape of zone B, has a radius which, toward the end of the zone, makes a transition to a short straight line that serves as a flow guiding element, thereby greatly minimizing eddy formation, thus greatly reducing fluttering and vibration. Another important effect achieved by means of the flow guiding element is the reduction of turbulence in the flow downstream of zone C, ensuring that the closing element occupies a more stable position in the flow, even when installed in a horizontal direction, and in this way the flow coefficient is held constant.

The cylindrical stem of the closing element, which adjoins zone C, serves as a guide, making it impossible for the closing element to turn or to rotate in the flow direction. The guide of the closing element is guided positively by a bearing provided in the valve housing and is thereby stabilized. The guide for the closing element can additionally be used as a spring guide if a spring is desired or required.

Extending over the guide for the closing element are guide ribs to ensure that the guide for the closing element rests against the bearing in the valve housing only via the ribs and not over the entire periphery of the guide for the closing element. As a result, any dirt particles are flushed through the valve or the bearing in the valve housing, and closing of the valve or jamming of the closing element in the guide region through the accumulation of dirt is prevented or minimized. However, other embodiments of guides are also conceivable.

A spring supporting surface on the bearing in the valve housing provides the possibility of installing a return element, preferably a spring, in the valve in order to ensure reliable closure by the valve, even when installed in a horizontal position. By virtue of the fact that the valve can also be installed in a horizontal position, the closing element without a spring and in the absence of flow is in an undefined position. Installing a spring ensures that the closing element is pressed against the profile seal.

A spring is also advantageous in the case of materials for the closing element which have a low relative density and thus close the valve only poorly through their own weight when installed vertically, and it can also be retrofitted without problems in such a valve design without replacing the existing components, such as the housing or the closing element. This reduces production costs since the same components can be used for both variant embodiments, with and without a spring.

Another advantage in the case of a valve with a closing element having an outer contour as in the present invention is that, in the case of a plastic embodiment of the closing element, the location chosen for the gate mark and the parting seam can be one in which it has no effect on the flow, e.g. at the end of the guide.

A preferred embodiment consists in attaching blades to the periphery in the region of the flow-optimized circumferential surface of zone A, said blades producing rotation of the closing element as the medium flows through the check valve. This, in turn, enables the check valve to perform a self-cleaning action and to allow through the dirt particles. Since, in most cases, the closing element floats in the medium and does not rest against the stop surface of the bearing of the valve housing, the rotation produced is an efficient cleaning method which takes place constantly in an autonomous fashion.

Another possibility for embodiment consists in the guide ribs having a spiral course on the guide of the closing element, assisting rotation and expelling the dirt particles.

### BRIEF DESCRIPTION OF THE DRAWINGS

Illustrative embodiments of the invention are described with reference to the figures, although the invention is not restricted to the illustrative embodiments. In the drawing:

FIG. 1 shows a longitudinal section of a check valve in the opened state,

FIG. 2 shows a sectional view through the valve housing,

FIG. 3 shows a three-dimensional view of a check valve with a longitudinal segment removed and in the closed position,

FIG. 4 shows a longitudinal section of a check valve having a spring in the closed position,

FIG. 5 shows a view of the closing element divided into the respective zones, and

FIG. 6 shows a plan view and a side view of a variant embodiment of a closing element.

### DETAILED DESCRIPTION

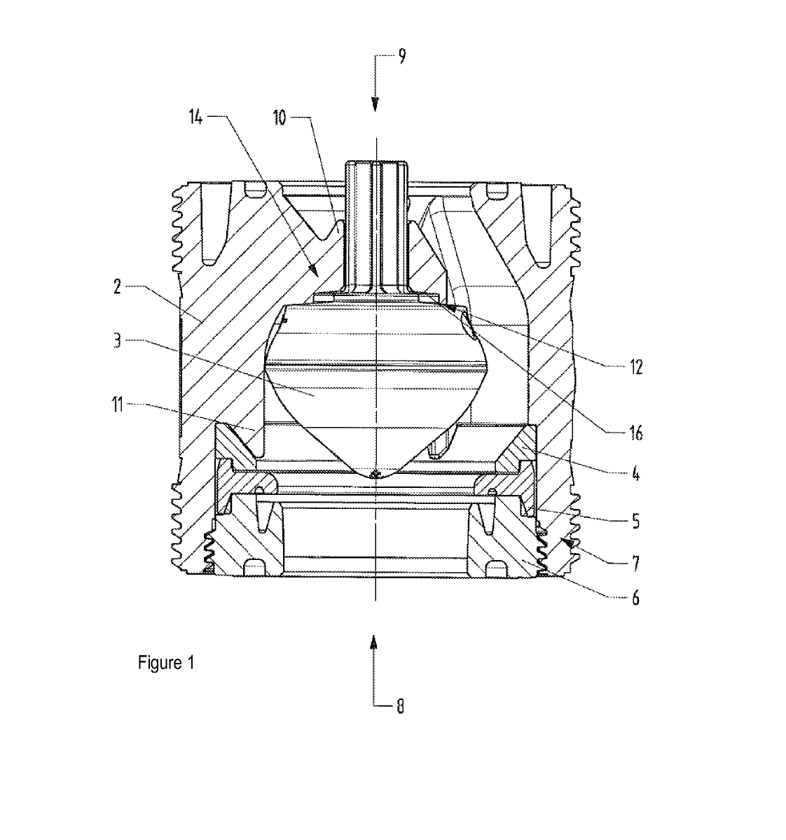

The check valve 1 in FIG. 1 has a valve housing 2, in which there is a closing element 3 for flow control, i.e. the closing element prevents the medium from flowing back and allows it to flow through in only one direction. A flow passes through the check valve 1 in the direction of arrow 8, ensuring that the closing element 3 remains in the opened position. On the inflow side of the valve 1 there is the sealing section 7, which ensures leaktightness when the check valve 1 is closed. The sealing section 7 is composed of a profile seal 5, a backing ring 4 and a screw-in part 6. In this case, the profile seal 5 is clamped securely between the backing ring 4 and the screw-in part 6. The screw-in part 6 is screwed into the valve housing 2 and is tightened until the backing ring 4 rests against the valve housing 2. The closing element 3 is guided by means of the bearing 10, which is fixed and positioned concentrically in the valve housing 2 by means of the ribs 11. To fix the bearing 10 in the valve housing 2, there are ideally three ribs 11 distributed uniformly along the periphery, although more than three ribs 11 can be imagined, in which case, however, the flow resistance is increased in an unwanted manner.

The bearing 10 has a stop surface 12, against which the closing element 3 rests in the opened state. Moreover, the bearing 10 has a supporting surface 16, which is slightly recessed relative to the stop surface 12. The surface 16 is used to support a spring 15, which can be installed if required. If the medium does not arrive in flow direction 8, the closing element 3 falls in the closing direction and prevents a backflow 9 of the medium.

The parts are preferably produced from plastic, but other materials, such as copper, steel, brass etc. are also conceivable.

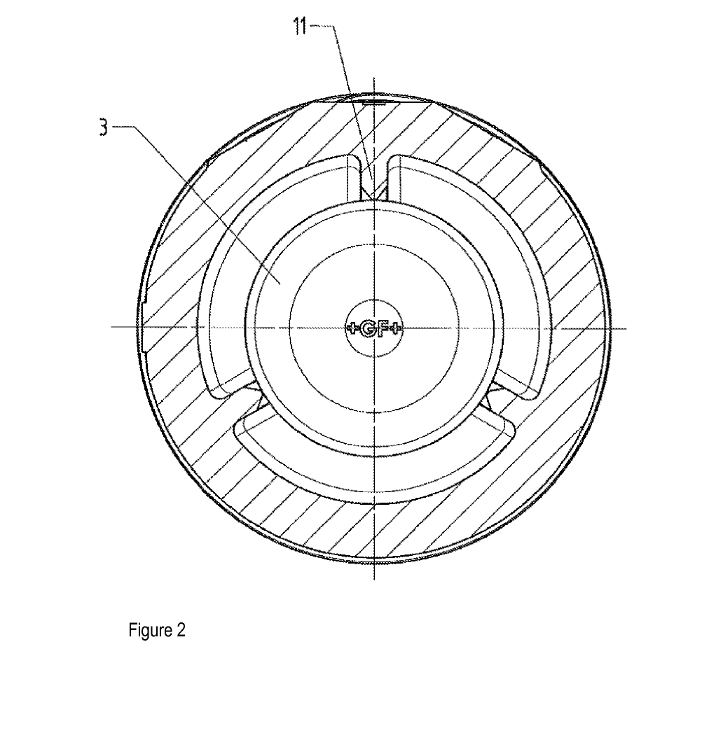

The ribs 11, by means of which the bearing 10 is secured on the valve housing 2, furthermore serve as a guide for the closing element 3, this being apparent in FIG. 2. As a result, bending during the movement of the closing element 3 is impossible.

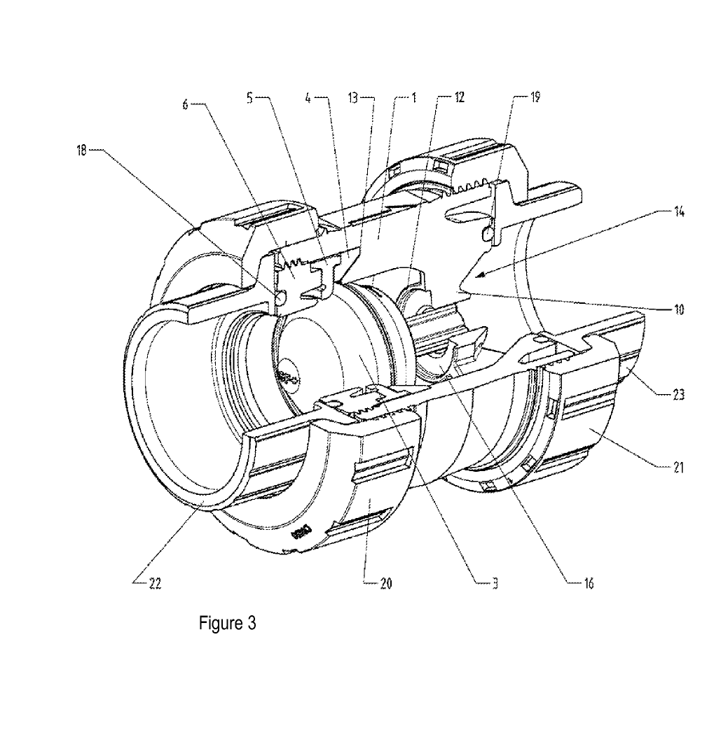

The valve housing 2 is provided at both ends with external threads, onto which union nuts 20, 21 are screwed. By means of the union nuts 20, 21, a connection part 22, 23 is pressed against an O-ring 18, 19, which is situated in the front end of the screw-in part 6 or in the front end of the valve housing 2 on the outlet side. The screw-in part 4 is screwed in by means of the internal thread arranged in the valve housing 2, thereby pressing the backing ring 4 against the end face 13 of the valve housing 2 via the profile seal 5. In FIG. 3, the closing element 3 is in a closed position. The closing element 3 presses on the profile seal 5 by means of the radius of the spherical shape or domed shape of zone B 35, while the screw-in part 6 serves to stabilize the profile seal 5 to ensure that the profile seal 5 cannot give way and that the closing element 3 cannot slide through if the pressure acting on the closing element 3 is too high.

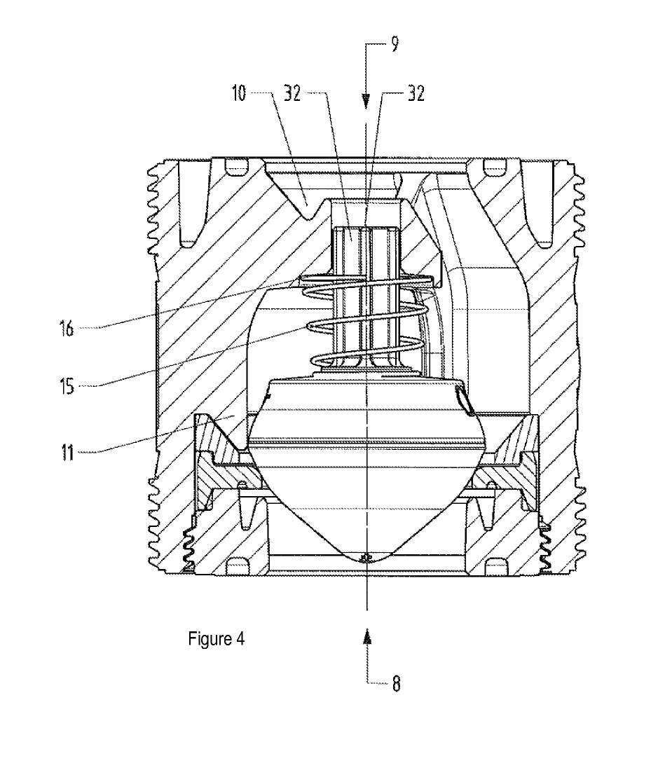

FIG. 4 shows a check valve 1 in which a spring 15 is used to ensure reliable sealing between the closing element 3 and the profile seal 5, even if the valve 1 is installed horizontally, for example. By means of the spring 15, a pressure is exerted on the closing element 3, as a result of which the valve 1 is closed until a flow that produces sufficient pressure in flow direction 8 to overcome the counterpressure of the spring 15 occurs. It is also appropriate to install a spring 15 of this kind if the material used for the closing element 3 has a low specific weight and the valve 1 cannot be adequately closed solely by the intrinsic weight thereof. The guide 32 for the closing element 3 furthermore serves as a guide for the spring 15 resting against the supporting surface 16. Four guide ribs 33 are arranged on the guide 32, although a different number of guide ribs 33 is also conceivable. In this way, the guide 32 does not rest over the entire periphery in the bearing 10 but only via the guide ribs 33 and, as a result, friction can be significantly reduced and the closing element 3 is nevertheless guided concentrically with respect to the valve housing 2, although other embodiments of guides are also conceivable.

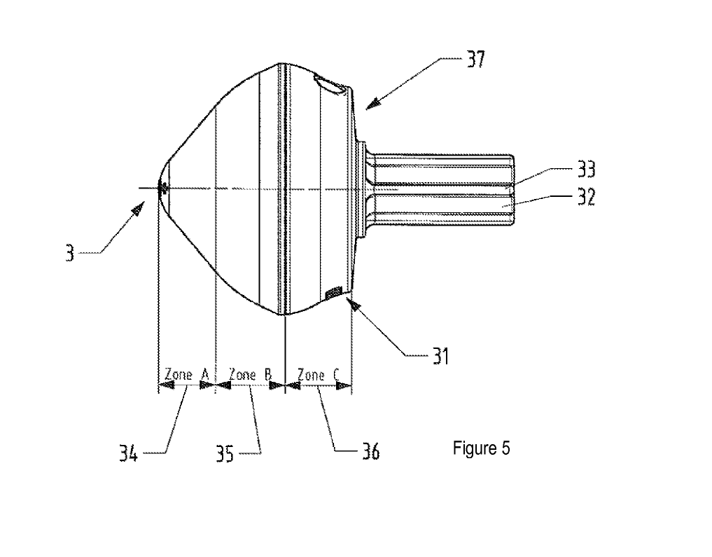

In order to achieve and hold constant the desired flow rate or desired flow coefficient and to obtain the required leaktightness, the outer contour of the closing element 3 consists of different zones, which are illustrated in FIG. 5. Zone A 34 has a flow-optimized outer contour, it also being possible for the outer contour in zone A 34 to be conical in shape. The curve is shaped in such a way that resistance in the valve 1 is minimal and, as a result, the valve 1 achieves very good flow values.

Adjoining the curve of zone A 34 is the spherical shape or domed shape of zone B 35, which serves to provide optimum sealing of the check valve 1. Arranging the geometries in series thus ensures both leaktightness in the closed position and also a minimum flow resistance while the valve 1 is open, this being achieved by zone A 34. In zone C 36, which adjoins zone B 35, a radius, which does not have to correspond to the spherical radius of zone B 35, makes a transition to a straight line which is not tangential to the radius, giving rise to a flow guiding element 31. The flow guiding element 31 brings about a more stable position of the closing element 3, that is to say that the flow coefficient or flow volume remains constant. The use of the flow guiding element 31 reduces turbulence and thus also reduces the backpressure acting on the supporting surface 37 of the closing element 3. The outer contour of the closing element 3, which consists of a flow-optimized curve, a spherical shape or domed shape that provides optimum sealing, and a flow guiding element, reduces vibration, holds the flow coefficient constant, reduces noise and furthermore enables the check valve to be supplemented by a spring without problems.

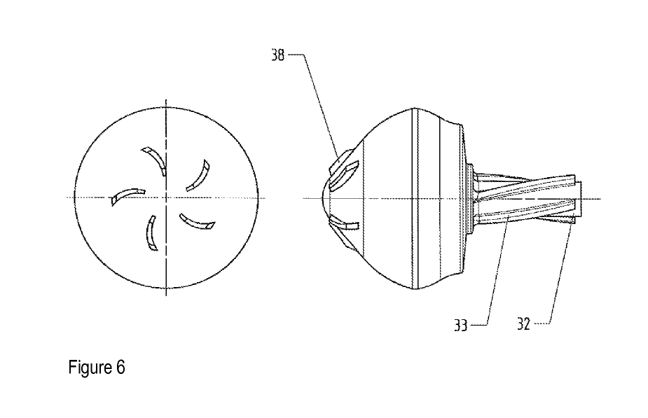

FIG. 6 shows one embodiment of a closing element 3, which has blades 38 along the periphery of the flow-optimized outer contour in the region of zone A 34. The blades 38 are distributed uniformly along the periphery. In the depicted embodiment, the closing element 3 has five blades 38, but a different number of blades 38 is also conceivable. The blades 38 have a slight curvature, this being helpful in the production of rotation arising from the medium flowing through in flow direction 8. The effect of the rotation of the closing element 3 is to aid the self-cleaning of the check valve 1. The rotation frees the dirt particles from the sealing section 7 and the guide section 14. By virtue of the fact that the closing element 3 normally floats in the medium flowing through and rests against the stop surface 12 only in a few cases, which would make rotation of the closing element 3 more difficult, this effect is possible. In the embodiment illustrated in FIG. 6, the guide 32 has ribs 33 which extend in a spiral shape along the cylindrical periphery of the guide 32; through their spiral arrangement, they promote the rotary motion of the closing element 3 and the conveyance of the dirt particles through the check valve 1. A combination of straight guide ribs 33 along the guide 32 and blades 38 on the periphery in the region of zone A 34, as illustrated in FIG. 6, is also conceivable.

### LIST OF REFERENCE SIGNS

1 check valve
2 valve housing
3 closing element
4 backing ring
5 profile seal
6 screw-in part
7 sealing section
8 flow direction
9 backflow direction
10 bearing
11 rib
12 stop surface
13 end face
14
15 spring
16 supporting surface
17
18 O-ring
19 O-ring
20 union nut
21 union nut
22 connection part
23 connection part
24
31 flow guiding element
32 guide, closing element
33 guide rib, closing element
34 zone A
35 zone B
36 zone C
37 supporting surface, closing element
38 blade

1. A check valve comprising a valve housing, a one-piece closing element arranged in the housing in such a way that the closing element is displaced by a flow medium, wherein the housing is provided with a sealing region provided with a profile seal wherein the closing element rests against the profile seal of the sealing section when in a closed position, wherein the closing element is guided by a bearing, arranged concentrically in the valve housing by means of ribs, wherein the closing element comprises a zone A, in which the outer contour comprises a flow-optimized shape, and a zone B, in which the outer contour comprises a domed shape, and zones A and B are arranged in series and merge smoothly into one another.

2. The check valve as claimed in claim 1, wherein the outer contour of zone A is of conical design.

3. The check valve as claimed in claim 1, wherein the outer contour of zone A merges tangentially into the dome of zone B.

4. The check valve as claimed in claim 1, wherein the closing element further comprises a zone C which has a flow guiding element for minimizing eddy formation.

5. The check valve as claimed in claim 1, wherein the closing element has a guide for guiding the closing element and allowing the closing element to be moved in the flow direction.

6. The check valve as claimed in claim 5, wherein the guide has at least three guide ribs.

7. The check valve as claimed in claim 1, wherein the bearing has a supporting surface for supporting a return element.

8. The check valve as claimed in claim 7, wherein the return element is a spring.

9. The check valve as claimed in claim 8, wherein the spring is a compression spring.

10. The check valve as claimed in claim 1, wherein the closing element is manufactured from plastic.

11. The check valve as claimed in claim 1, wherein at least one spiral shape blade is arranged along a periphery of a circumferential surface of zone A, to produce rotation.

12. The check valve as claimed in claim 6, wherein the guide ribs extend in a spiral shape.
